(19) United States
(12) Patent Application Publication
(10) Pub. No.: US 2026/0213243 A1
(43) Pub. Date: Jul. 23, 2026

(54) FUEL CELL STACK

(71) Applicant: TOYOTA JIDOSHA KABUSHIKI KAISHA, Toyota-shi (JP)

(72) Inventor: Hiroki HARA, Nisshin-shi (JP)

(73) Assignee: TOYOTA JIDOSHA KABUSHIKI KAISHA, Toyota-shi (JP)

(21) Appl. No.: 19/391,792

(22) Filed: Nov. 17, 2025

(30) Foreign Application Priority Data
Jan. 23, 2025 (JP) 2025-009582

(51) Int. Cl. H01M 8/248; H01M 8/04082; H01M 8/2457

(52) U.S. Cl. CPC H01M 8/248; H01M 8/04201; H01M 8/2457

(57) ABSTRACT

A fuel cell stack disclosed in the present specification includes a plurality of subunits that is stacked. Each of the subunits includes a pair of pressure plates, a plurality of unit cells stacked between the pressure plates, and a linking member that links the pressure plates while pressurizing the unit cells in a stacking direction. Each of the pressure plates is provided with a hydrogen channel through which hydrogen used in reaction in the unit cell passes and an oxygen channel through which oxygen used in reaction in the unit cell passes. Two of the subunits adjacent to each other are connected, and in the two subunits that are adjacent, the hydrogen channels are connected to each other and the oxygen channels are connected to each other. The unit cells are pressurized in each of the subunits, and accordingly, there is no need to pressurize the entire FC stack.

### CROSS-REFERENCE TO RELATED APPLICATION

This application claims priority to Japanese Patent Application No. 2025-009582 filed on Jan. 23, 2025. The disclosure of the above-identified application, including the specification, drawings, and claims, is incorporated by reference herein in its entirety.

### BACKGROUND

### 1. Technical Field

The technology that is disclosed in the present specification relates to a fuel cell stack.

### 2. Description of Related Art

A fuel cell stack has a structure in which a plurality of unit cells is stacked. In a fuel cell stack, a stack of a plurality of unit cells is placed in a case, and the stack is maintained in a state of being pressurized in a stacking direction (e.g., Japanese Unexamined Patent Application Publication No. 2005-056814 (JP 2005-056814 A) and Japanese Unexamined Patent Application Publication No. 2012-059712 (JP 2012-059712 A)). Alternatively, the stack of the unit cells may be held by a frame instead of a case (e.g., Japanese Unexamined Patent Application Publication No. 2023-134285 (JP 2023-134285 A)). The frame holds the stack in a state of being pressurized in the stacking direction.

### SUMMARY

Users have a variety of needs regarding output of fuel cells. Output of a fuel cell is determined by the number of unit cells that are stacked. In other words, the number of unit cells to be stacked needs to be changed in accordance with the needs of the user. Making a case or frame in accordance with the number of stacked units is costly. The present specification provides technology for realizing a fuel cell stack with an output (number of stacked unit cells) in accordance with user demand, at low costs.

A fuel cell stack that is disclosed in the present specification includes a plurality of subunits that is stacked. Each of the subunits includes a pair of pressure plates, a plurality of unit cells stacked between the pressure plates, and a linking member that connects the pressure plates while pressurizing the unit cells in a stacking direction. Each of the pressure plates is provided with a hydrogen channel through which hydrogen that is used in reaction in the unit cells passes, and an oxygen channel through which oxygen that is used in reaction in the unit cells passes. Two of the subunits that are adjacent to each other are connected to each other, and also the hydrogen channels are connected to each other and the oxygen channels are connected to each other in the two subunits that are adjacent to each other.

In the fuel cell stack that is disclosed in the present specification, the output (number of unit cells) can be changed by changing the number of subunits that are linked. The unit cells are pressurized in the subunits. Accordingly, it is sufficient to link subunits that are adjacent to each other, and there is no need to pressurize a stack of the subunits. That is to say, no case or frame to pressurize the stack of subunits is necessary. Accordingly, a fuel cell stack with output that is desired by the user can be provided at low costs.

Details of the technology that is disclosed in the present specification and further improvements will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a fuel cell stack according to an embodiment;

FIG. 2 is a perspective view of a subunit;

FIG. 3 is a perspective view of a subunit according to a first modification; and

FIG. 4 is a perspective view of a subunit according to a second modification.

### DETAILED DESCRIPTION OF EMBODIMENTS

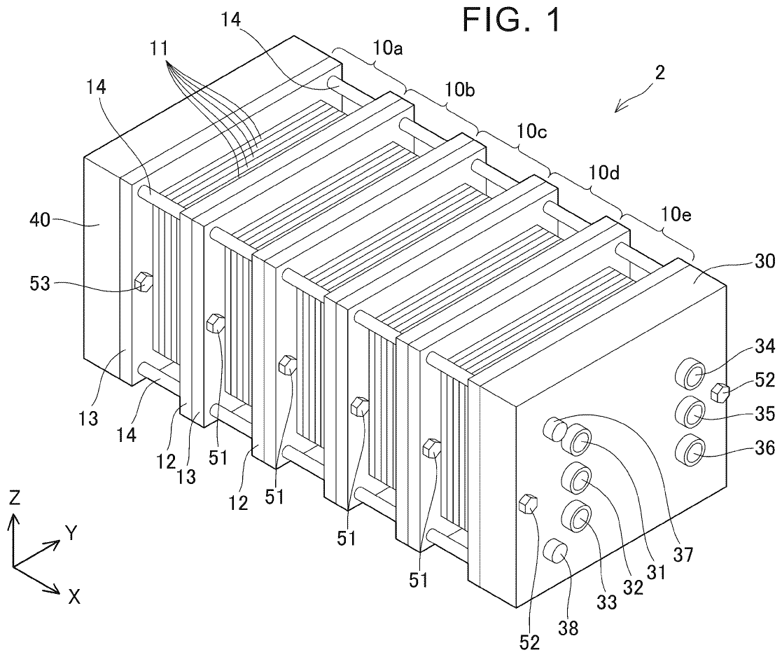

A fuel cell stack 2 according to an embodiment will be described below with reference to the drawings. FIG. 1 is a perspective view of the fuel cell stack 2. For convenience of description, the term “fuel cell stack” will be written as “FC stack” below. “FC” stands for “Fuel Cell.”

The FC stack 2 includes a plurality of subunits 10a, 10b, 10c, 10d, and 10e, and a pair of end plates 30 and 40. The subunits 10a, 10b, 10c, 10d, and 10e have the same structure. In the following description, any one of the subunits 10a, 10b, 10c, 10d, and 10e will be referred to as “subunit 10” without distinction. The subunits 10 are stacked, and a stack of the subunits 10 is sandwiched between the end plates 30 and 40. An X direction in a coordinate system in the drawings matches a stacking direction. Although five subunits 10 are stacked in FIG. 1, the number of subunits 10 that are stacked in the FC stack 2 may be any number.

Two subunits 10 that are adjacent to each other are fixed to each other by bolts 51. The end plate 40 is fixed to the subunit 10a at one end by bolts 53. The end plate 30 is fixed to the other end subunit 10e by bolts 52.

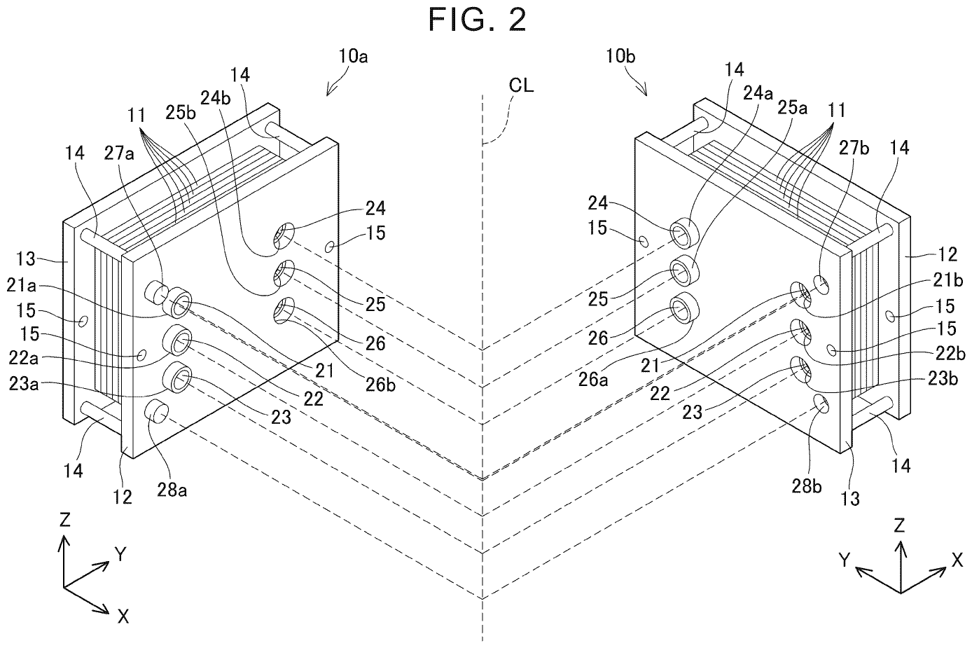

FIG. 2 is a perspective view of the two subunits 10a and 10b. In FIG. 2, the subunit 10a is drawn on a left side of a center line CL, and the subunit 10b is drawn on a right side thereof. Note that in FIG. 2, the viewpoints are different on the right side and the left side of the center line CL. The drawing on the right side depicts the subunit 10b from a viewpoint that is obtained by rotating the coordinate system in the drawing on the left by 90 degrees about a Z axis.

One subunit 10 is made up of a plurality of unit cells 11 making up the fuel cell, and a pair of pressure plates 12 and 13. The unit cells 11 are stacked. The X direction of the coordinate system in the drawings matches the stacking direction of the unit cells 11. Each of the unit cells 11 is a power generation unit of the fuel cell. In the case of a polymer electrolyte fuel cell, a membrane electrode assembly (MEA) corresponds to the unit cell 11. One face of the unit cell in the stacking direction is a cathode, and the other face is an anode. Stacking multiple unit cells 11 enables high output voltage and output current to be obtained. In the drawings, the unit cells 11 are each represented as a simple plate, and detailed structure thereof is omitted from illustration.

A stack of the unit cells 11 is sandwiched between the pressure plates 12 and 13. The pressure plates 12 and 13 are linked by four linking members 14 (one linking member 14 is hidden by the unit cell 11, or the pressure plates 12 and 13, and is not visible). When viewed along the X direction of the coordinate system in the drawing, the four linking members 14 are disposed so as to surround the unit cells 11. The four linking members 14 pressurize the unit cells 11 in the stacking direction, while linking the pressure plates 12 and 13 on both sides thereof.

Each of the pressure plates 12 and 13 of the subunit 10 is provided with an oxygen supply channel 21 for supplying oxygen to the unit cell 11, a hydrogen supply channel 22 for supplying hydrogen, and a refrigerant supply channel 23 for supplying a refrigerant. Also, each of the pressure plates 12 and 13 is provided with an oxygen discharge channel 24 for discharging oxygen not used in the reaction, a hydrogen discharge channel 25 for discharging hydrogen not used in the reaction and water, and a refrigerant discharge channel 26 for discharging the refrigerant after cooling the unit cell 11. Similar channels are provided in the unit cells 11, and oxygen that is supplied through the oxygen supply channel 21 is supplied to each of the unit cells 11. The oxygen not used in the unit cells 11 is discharged to the outside of the subunit 10 through the oxygen discharge channel 24. The same is true regarding the other channels 22, 23, 25, and 26, as well.

The oxygen supply channel 21 of the pressure plate 12 has a protrusion 21a that protrudes from an outer-side face of the pressure plate 12 (face facing adjacent subunit 10b) towards the subunit 10b. In the same way, the hydrogen supply channel 22 (refrigerant supply channel 23) also has a protrusion 22a (23a) that protrudes from the outer-side face of the pressure plate 12 toward the subunit 10b. Also, the oxygen supply channel 21 of the pressure plate 13 of the subunit 10b has a recess 21b that fits with the protrusion 21a of the oxygen supply channel 21 of the pressure plate 12 of the subunit 10a that it faces. In the same way, the hydrogen supply channel 22 of the pressure plate 13 of the subunit 10b has a recess 22b that fits with the protrusion 22a of the hydrogen supply channel 22 of the pressure plate 12 of the subunit 10a that it faces. The refrigerant supply channel 23 of the pressure plate 13 of the subunit 10b has a recess 23b that fits with the protrusion 23a of the refrigerant supply channel 23 of the pressure plate 12 of the subunit 10a that it faces.

The oxygen discharge channel 24 of the pressure plate 13 of the subunit 10b has a protrusion 24a that protrudes from an outer-side face of the pressure plate 13 (face facing adjacent subunit 10a) toward the subunit 10a. In the same way, the hydrogen discharge channel 25 (refrigerant discharge channel 26) also has a protrusion 25a (26a) that protrudes from the outer-side face of the pressure plate 13 toward the subunit 10a. Also, the oxygen discharge channel 24 of the pressure plate 12 of the subunit 10a has a recess 24b that fits with the protrusion 24a of the oxygen discharge channel 24 of the pressure plate 13 of the subunit 10b that it faces. In the same way, the hydrogen discharge channel 25 of the pressure plate 12 of the subunit 10a has a recess 25b that fits with the protrusion 25a of the hydrogen discharge channel 25 of the pressure plate 12 of the subunit 10b that it faces. The refrigerant discharge channel 26 of the pressure plate 12 of the subunit 10a has a recess 26b that fits with the protrusion 26a of the refrigerant discharge channel 26 of the pressure plate 13 of the subunit 10b that it faces.

In the FC stack 2, the two subunits 10a and 10b are adjacent to each other. The pressure plate 12 of the subunit 10a faces the pressure plate 13 of the subunit 10b, and the two subunits 10a and 10b are joined together. At this time, the protrusion 21a fits into the recess 21b. In the same way, the protrusion 22a (23a) of the pressure plate 12 of the subunit 10a fits into the recess 22b (23b) of the pressure plate 13 of the subunit 10b. Note that a gasket that is omitted from illustration is provided around the protrusion 21a (22a, 23a), and when the recess 21b (22b, 23b) is fitted thereto, a gap therebetween is sealed. In the same way, the protrusion 24a (25a, 26a) of the subunit 10b fits into the recess 24b (25b, 26b) of the subunit 10a.

Also, a cathode terminal 27a and an anode terminal 28a of the stack of unit cells 11 are provided on the pressure plate 12 of the subunit 10a. Both the cathode terminal 27a and the anode terminal 28a have a protruding shape. A cathode terminal 27b and an anode terminal 28b of the stack of unit cells 11 are provided on the pressure plate 13 of the subunit 10b. Both the cathode terminal 27a and the anode terminal 28a have a recessed shape that is sunken from a surface of the pressure plate 13. When the subunits 10a and 10b are stacked, the protruding cathode terminal 27a of the subunit 10a fits into the recessed cathode terminal 27b of the subunit 10b. The protruding anode terminal 28a of the subunit 10a fits into the recessed anode terminal 28b of the subunit 10b.

When the subunits 10a, 10b are stacked, a plurality of the protrusions 21a, 22a, and 23a of the subunit 10a fits into a plurality of the recesses 21b, 22b, and 23b of the subunit 10b. In the same way, the protruding cathode terminal 27a and the anode terminal 28a of the subunit 10a fit into the recessed cathode terminal 27b and the anode terminal 28b of the subunit 10b. Conversely, a plurality of the protrusions 24a, 25a, and 26a of the subunit 10b fits into a plurality of the recesses 24b, 25b, and 26b of the subunit 10a. In this way, the two subunits 10a and 10b that are adjacent to each other are firmly joined together without any misalignment with each other. Also, the subunits 10a and 10b that are adjacent to each other are linked to each other by bolts 51 through bolt holes 15.

With all of the subunits 10, two subunits 10 that are adjacent to each other are linked in the same manner. The end plate 30 is linked to the subunit 10e at the end of the FC stack 2 by the bolts 52. The end plate 30 is provided with an oxygen supply port 31 that is connected to the oxygen supply channel 21 of the subunit 10e. The end plate 30 is also provided with a hydrogen supply port 32 (refrigerant supply port 33) that is connected to the hydrogen supply channel 22 (refrigerant supply channel 23) of the subunit 10e. Further, the end plate 30 is provided with an oxygen discharge port 34 (hydrogen discharge port 35 (refrigerant discharge port 36)) that is connected to the oxygen discharge channel 24 (hydrogen discharge channel 25, refrigerant discharge channel 26) of the subunit 10e. Although omitted from illustration, the end plate 40 that is linked to the subunit 10a is provided with a U-shaped channel connecting the oxygen supply channel 21 and the oxygen discharge channel 24 of the subunit 10a. In the same way, the end plate 40 is also provided with a U-shaped channel that connects the other channels.

In an FC system including the FC stack 2, oxygen (air) is supplied to the oxygen supply port 31 of the FC stack 2, hydrogen is supplied to the hydrogen supply port 32, and refrigerant is supplied to the refrigerant supply port 33. Oxygen (hydrogen, refrigerant) that is supplied to the oxygen supply port 31 (hydrogen supply port 32, refrigerant supply port 33) is supplied to all of the unit cells 11 through the oxygen supply channel 21 (hydrogen supply channel 22, refrigerant supply channel 23) of each of the subunits 10. Oxygen (hydrogen) remaining after usage in the unit cells 11 passes through the oxygen discharge channel 24 (hydrogen discharge channel 25) of each of the subunits 10 and is ultimately discharged from the oxygen discharge port 34 (hydrogen discharge port 35) of the end plate 30. Similarly, the refrigerant used in the unit cells 11 passes through the refrigerant discharge channels 26 of each of the subunits 10 and is ultimately discharged from the refrigerant discharge port 36 of the end plate 30.

The unit cells 11 that are stacked in the FC stack 2 need to be maintained pressurized in the stacking direction. In the FC stack 2 of the embodiment, in each of the subunits 10, the unit cells 11 are maintained in a pressurized state. Also, the output of the FC stack 2 according to the embodiment can be changed by changing the number of subunits 10 that are stacked. The number of subunits 10 that are stacked in the FC stack 2 can be changed according to user desires. At this time, it is not necessary to pressurize the entire stack of the subunits 10. It is sufficient for the subunits 10 that are adjacent to each other to be linked so as not to be separated from each other. In the case of the FC stack 2 of the embodiment, two subunits 10 that are adjacent to each other are linked by bolts 51. The FC stack 2 does not require pressurizing of the entire stack of subunits, and also the number of subunits 10 to be stacked can be easily changed. The FC stack 2 according to the embodiment can realize a fuel cell stack with an output (number of stacked unit cells) that meets user demand at low costs.

Further, one of two subunits 10, which are adjacent to each other, is provided with the protrusions that protrude toward the other, and the other is provided with recesses that fit with the protrusions. This structure enables two subunits 10 that are adjacent to each other to be stacked without being misaligned with each other. Furthermore, the channels are provided inside the protrusions and the recesses, and the channels of the two subunits 10 are linked by fitting the protrusions and the recesses together. Gaskets are provided around the protrusions, and when the recesses fit into place, the channels between the two are blocked (sealed) from the outside. This structure also contributes to reducing the cost of the FC stack.

The end plate 30 is provided with a cathode terminal 37 that is connected to the cathode terminal 27a of the subunit 10e that is adjacent thereto, and an anode terminal 38 that is connected to the anode terminal 28a of the subunit 10e. Note that as described above, the cathode terminal 27a (anode terminal 28a) of one of two subunits 10 that are adjacent to each other is connected to the cathode terminal 27b (anode terminal 28b) of the other. The cathode terminal 27a (anode terminal 28a) has a protruding shape, and the cathode terminal 27b (anode terminal 28b) has a recessed shape. When subunits 10 that are adjacent to each other are joined, the protruding cathode terminal 27a (anode terminal 28a) fits into the recessed cathode terminal 27b (anode terminal 28b), and also is electrically connected thereto. The protruding cathode terminal 27a (anode terminal 28a) and the recessed cathode terminal 27b (anode terminal 28b) also contribute to subunits 10 that are adjacent to each other being joined without being misaligned.

In the FC stack 2, in all of the subunits 10, the cathode terminals are connected to each other, and the anode terminals are connected to each other. That is to say, the multiple subunits 10 are electrically connected in parallel. In the FC stack 2, increasing the number of subunits 10 that are stacked does not increase the output voltage, but the electrical capacity that can be stored increases.

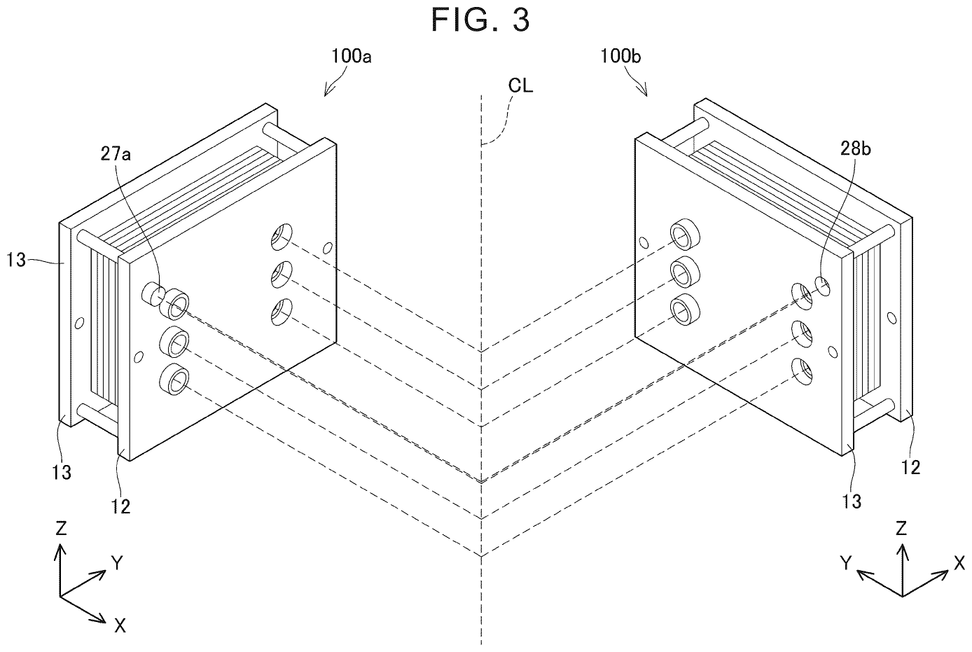

FIG. 3 illustrates subunits 100a and 100b of an FC stack according to a first modification. FIG. 3 corresponds to FIG. 2. In the subunit 100a, a protruding cathode terminal 27a is provided on the pressure plate 12 facing the subunit 100b. On the other hand, in the subunit 100b, the recessed anode terminal 28b is provided on the pressure plate 13 facing the subunit 100a. In the subunits 100a and 100b, the position of the recessed anode terminal 28b is different from that of the subunit 10 of the embodiment. The rest of the structures of the subunits 100a and 100b is the same as that of the subunit 10, and accordingly reference numerals of some components are omitted in FIG. 3.

In the subunit 100, the unit cells 11 are electrically connected in series. The cathode terminal 27a and the anode terminal 28b respectively correspond to the cathode and the anode of the serial connection of the unit cells 11. When a plurality of the subunits 100 is stacked, the cathode terminal 27a of one of two subunits that are adjacent to each other is connected to the anode terminal 28b of the other subunit. Subunits that are adjacent to each other are connected in series. Accordingly, in the FC stack according to the first modification, the output voltage can be changed by changing the number of subunits 100 that are stacked.

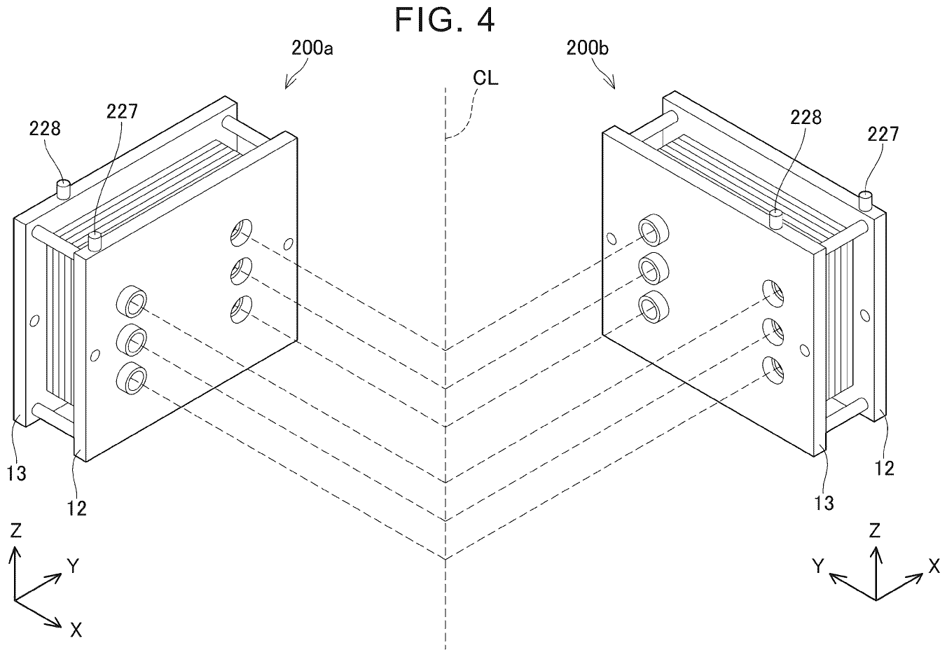

FIG. 4 illustrates subunits 200a and 200b of an FC stack according to a second modification. FIG. 4 corresponds to FIG. 2. In the subunits 200a and 200b, a cathode (cathode terminal 227) of the unit cells 11 that are connected in series is provided on a top portion of the pressure plate 12. Also, an anode (anode terminal 228) of the unit cells 11 that are connected in series is provided on a top portion of the pressure plate 13. The subunits 200a and 200b have a different structure of the cathode terminal and the anode terminal from the subunits 10 of the embodiment. The rest of the structures of the subunits 200a and 200b is the same as that of the subunits 10, and accordingly reference numerals of some components are omitted in FIG. 4.

In the FC stack according to the second modification, the cathode terminal 227 (anode terminal 228) of each of a plurality of the subunits 200 is not connected to either the cathode terminal 227 or the anode terminal 228 of the other subunits 200. In the FC stack of the second modification, after stacking the subunits 200, a plurality of the cathode terminals 227 is linked and a plurality of the anode terminals 228 is linked using separate conductors. Thus, the subunits 200 are electrically connected in parallel.

Alternatively, in the FC stack of the second modification, the subunits 200 are stacked, and then another conductor is used to connect the cathode terminal 227, of one of subunits that are adjacent to each other, to the anode terminal 228 of the other. Thus, the multiple subunits 200 are electrically connected in series. In the FC stack of the second modification, whether the subunits are connected to each other in series or in parallel can be selected.

Points to be noted regarding the technology that is described in the embodiment will be described. One subunit may contain any number of unit cells. Also, one FC stack may contain any number of subunits.

The main features of the FC stack 2 are as follows. The subunit 100 includes the pressure plates 12 and 13, the unit cells 11 that are stacked between the pressure plates 12 and 13, and the linking members 14, in which the linking members 14 link the pressure plates 12 and 13 while pressurizing the unit cells 11 in the stacking direction (X direction of coordinate system in drawings). Each of the pressure plates 12 and 13 is provided with an oxygen channel (oxygen supply channel 21, oxygen discharge channel 24) through which oxygen used in the reaction in the unit cells 11 passes, and a hydrogen channel (hydrogen supply channel 22, hydrogen discharge channel 25) through which hydrogen used in the reaction passes. Also, in the FC stack 2, two of the subunits 10 that are adjacent to each other are linked to each other, and also the hydrogen channels are connected to each other and the oxygen channels are connected to each other in the two subunits 10 that are adjacent to each other.

In two subunits 100 that are adjacent to each other, the oxygen channel (oxygen supply channel 21) of one subunit 100a has the protrusion 21a that protrudes toward the other subunit 100b, and the oxygen channel (oxygen supply channel 21) of the other subunit 100b has the recess 21b that fits with the protrusion 21a. The same is true regarding the hydrogen supply channel 22 and the refrigerant supply channel 23 as well.

Note that in the FC stack 2 of the embodiment, one of the pressure plates 12 has the cathode terminal 27a and the anode terminal 28a that are protruding, and the pressure plate 13 of the subunit 10b that joins with the pressure plate 12 has the recessed cathode terminal 27b that fits with the cathode terminal 27a and the recessed anode terminal 28b that fits with the anode terminal 28a.

Of two subunits 100a and 100b that are adjacent, the pressure plate 12 of one subunit 100a is provided with the protrusions 21a, 22a, and 23a, and the recesses 24b, 25b, and 26b. The pressure plate 13 of the other subunit 200b (pressure plate 13 facing pressure plate 12 of subunit 200a) is provided with the recess 21b (22b, 23b) that fits with the protrusion 21a (22a, 23a) and the protrusion 24a (25a, 26a) that fits with the recess 24b (25b, 26b).

Although specific examples of the disclosure have been described in detail above, these are merely exemplary and do not limit the scope of the claims. The technology described in the claims includes various modifications and variations of the specific examples exemplified above. The technical elements described in the present specification or in the drawings exhibit technical usefulness alone or in various combinations, and are not limited to the combinations described in the claims at the time of filing the application. In addition, the technology exemplified in the present specification or drawings can achieve a plurality of purposes at the same time, and achieving one of the purposes itself has technical utility.

What is claimed is:

1. A fuel cell stack in which a plurality of subunits is stacked, wherein
each of the subunits includes
a pair of pressure plates,
a plurality of unit cells that is stacked between the pressure plates, and
a linking member that connects the pressure plates while pressurizing the unit cells in a stacking direction,
each of the pressure plates is provided with a hydrogen channel through which hydrogen that is used in reaction in the unit cells passes, and an oxygen channel through which oxygen that is used in reaction in the unit cells passes, and
two of the subunits that are adjacent to each other are linked to each other, and also the hydrogen channels are connected to each other and the oxygen channels are connected to each other in the two subunits that are adjacent to each other.

2. The fuel cell stack according to claim 1, wherein the oxygen channel of one of the two subunits that are adjacent to each other includes a protrusion that protrudes toward the other subunit, and the oxygen channel of the other subunit includes a recess that fits with the protrusion.
